(19) United States
(12) Patent Application Publication
(10) Pub. No.: US 2019/0079985 A1
(43) Pub. Date: Mar. 14, 2019

(54) SCROLLING BETWEEN ELEMENTS IN A LIST

(71) Applicant: MOTOROLA SOLUTIONS, INC., Chicago, IL (US)

(72) Inventors: Valentina Dmitrievna Borisova, Saint-Petersburg (RU); Fedor Grigorievich Saveliev, Saint-Petersburg (RU)

(21) Appl. No.: 16/070,744

(22) PCT Filed: Jan. 28, 2016
(86) PCT No.: PCT/RU2016/000029

§ 371 Date: Jul. 17, 2018

(51) Int. Cl. G06F 17/30; G06F 3/0485; G06F 3/0482

(52) U.S. Cl. CPC G06F 17/30572; G06F 3/0482; G06F 3/0485

(57) ABSTRACT

A method and device of discrete scrolling between elements in a list of elements. The method includes displaying a list of elements, and receiving, via an input interface, a selection of a first element of the list of elements. The method also includes determining, with an electronic processor of the computing device, a type of the first element in response to receiving the selection of the first element, and determining a second element of the list of elements having a type that is the same as the type of the first element and being the closest element in the list of elements of the same type as the type of the first element. The method further includes receiving, at the processor of the computing device, a scroll command, and, in response to receiving the scroll command, displaying the second element at a predetermined location on the screen of the computing device.

### BACKGROUND OF THE INVENTION

Many computing devices, in particular, mobile computing devices, are configured to run different computer applications. Many of these applications such as, for example, music applications, calendar or timeline applications, file storage applications, image applications, navigation applications, electronic mail applications, and the like, generate and display lists including a plurality of elements. Since these lists may sometimes include hundreds of elements, the computing device may provide a tool or tools to facilitate navigation through the lists to locate an element of interest. One such tool is a filter. A filter typically requires that the user indicate a particular requirement (e.g., a particular characteristic) of the element via a separate user interface element (e.g., an additional window, a filter pane, a filter toolbar, and the like). The requirement may sometimes be, for example, a selected artist, genre, date, sender, receiver, geographical location, and the like, and may differ based on the application used to generate the list. Once the requirement has been identified, the computing device displays only the elements on the list that match the selected requirement, thereby keeping the rest of the elements on the list (i.e., the elements that do not match the selected requirement) hidden from view.

Another common tool used to navigate large lists is a search feature. A search feature requires a user to indicate a search parameter (e.g., a search string) via a separate user interface element, typically a search bar. Once the search parameter is defined, the computing device displays only the elements that match the search parameter while the rest of the elements on the list remain hidden from view.

These tools, however, are sometimes insufficient to efficiently navigate large lists of elements. First, both features require a separate user interface element. Additional user interface elements, however, utilize some screen space and reduce space available to display the list of elements, or other useful information. In particular, when the list is displayed on a mobile computing device (e.g., a smartphone), the screen is typically smaller, and, if too many items are displayed at once, can appear crowded and cumbersome.

Additionally, both a filter and a search tool only display elements that match the filter requirement or the search parameter, respectively. In other words, the filter and search tool hide those elements in the list that do not match the filter requirement or the search parameter, respectively. In some situations such as, for example, when navigating a calendar or other timeline application, adjacent elements provide a certain level of context to each other, which is hidden when using the filter and search tool.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an exemplary computing device.

FIG. 2 is a flowchart of a method of discretely scrolling through a list of elements.

FIG. 3 is a flowchart of a method for discretely scrolling through a timeline of events.

FIGS. 4A through 4C are exemplary screenshots illustrating discrete scrolling through a timeline of events.

FIGS. 5A through 5C are exemplary screenshots illustrating discrete scrolling through a list of electronic mails.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One exemplary embodiment provides a method of discrete scrolling between elements in a list of elements. In one instance, the method includes displaying, on a screen of a computing device, a list of elements, and receiving, via an input interface, a selection of a first element of the list of elements. The method also includes determining, with an electronic processor of the computing device, a type of the first element in response to receiving the selection of the first element, and determining a second element of the list of elements having a type that is the same as the type of the first element. The second element is the next element in the list of elements of the same type as the type of the first element. The method further includes receiving, at the electronic processor of the computing device, a scroll command, and, in response to receiving the scroll command, displaying the second element at a predetermined location on the screen of the computing device.

Another exemplary embodiment provides a computing device including a screen, an input interface, and an electronic processor coupled to the screen and the input interface. In one instance, the electronic processor is configured to display on the screen a list of elements, receive a selection, via the input interface, of a first element of the list of elements. The electronic processor is further configured to determine, in response to receiving the selection of the first element, a type of the first element, and receive, via the input interface, a scroll command. Finally, the electronic processor is configured to display, in response to receiving the scroll command, a second element of the list of elements at a predetermined location of the screen. The second element is associated with the same type as the first element, and the second element is a next element in the list of elements of the same type of the first element.

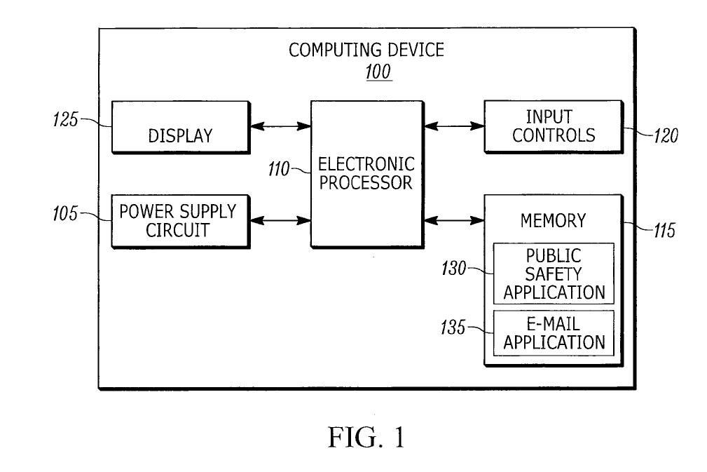

FIG. 1 illustrates an exemplary computing device 100. The computing device 100 can be, for example, a laptop computer, a tablet computer, a smart telephone, a mobile radio, a desktop computer, a portable media player, a personal digital assistant (PDA), or other device that displays lists of elements and facilitates user interaction with the lists of elements. In the illustrated embodiment, the computing device 100 is a mobile communication device such as, for example, a smart telephone. In the example shown in FIG. 1, the computing device 100 includes a power supply circuit 105, an electronic processor 110, a memory 115, input controls 120, and a display 125. In other embodiments, the device 100 can include a different number and different types of processors, memories, power supplies, displays, and the like.

The power supply circuit 105 receives power (e.g., from a removable battery) and distributes the electrical power to the other components of the computing device 100. The power supply circuit 105 may include additional electrical components such as, for example, a step-down controller, circuit protection circuitry, battery management circuit, and the like, to condition and manage the power received from an external source (e.g., battery or outlet) to the power requirements of the other components of the computing device 100.

The input controls 120 are illustrated schematically, but may include various physical buttons, knobs, dials, actuators, and the like configured to receive selections and/or commands from a user. The input controls 120 may extend through a housing of the computing device 100 to allow access by a user. The input controls 120 are electrically coupled to the electronic processor 110 to send the selections and/or commands received from the user to the electronic processor 110.

In addition to physical controls, the computing device 100 may include virtual or “soft” controls. For example, the electronic processor 110 may generate a graphical user interface (not shown, and displayed on the display 125) with various elements that are selectable using a cursor-control device, for example, a mouse (also not shown). In other embodiments, for example, in the illustrated embodiment, the computing device 100 is a mobile communication device that includes a touchscreen. When the computing device 100 includes a touchscreen, virtual buttons, “soft keys” and the like may be displayed on the touchscreen and selected via contact with the touchscreen with, for example, a stylus or a finger. The touchscreen may be, for example, a capacitive touchscreen, a resistive touchscreen, and the like.

The display 125 is electrically coupled to the electronic processor 110 and displays various information to the user based on signals received from the electronic processor 110. As discussed, in the illustrated embodiment, the display 125 is a touchscreen. The computing device 100 may include various output devices such as, for example, a speaker, a buzzer, and/or a vibratory element to provide auditory and haptic alerts to the user.

The memory 115 is electrically coupled to the electronic processor 110 and stores instructions for execution by the electronic processor 110. The memory 115 is a non-transitory computer readable medium and may include, for example, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. The memory 115 may additionally store information to be used by the electronic processor 110 when executing the instructions such as, for example, contact lists, images, media files, and the like. The memory 115 also stores a plurality of applications and the associated instructions to be executed by the electronic processor 110. Each application generates and displays information to the user automatically and/or according to received commands. In the illustrated embodiment, the memory 115 stores a public safety application 130 and an electronic mail application 135, which are described later. In other embodiments, the memory 115 may, alternatively or additionally, store other applications such as, for example, a music application, a file storage application, an image application, a navigation application, and the like. In some embodiments, the memory 115 can be divided into one or more portions or modules, each portion storing information for different applications, different types of information, and/or having different retaining time periods. The public safety application 130 and electronic mail application 135 are stored in the memory 115 and are configured to, among other things, generate and display lists including a plurality of elements. Each element in the list is associated with a specific type. The specific type of the element, however, varies based on, for example, the particular application (for example, the public safety application 130 or electronic mail application 135) used to generate the list, among other factors.

The electronic processor 110 is electrically coupled to the power supply circuit 105, the input controls 120, the display 125, and the memory 115. The electronic processor 110 retrieves and executes instructions from the memory 115. The electronic processor 110 receives selections and/or commands through the input controls 120 or the touchscreen, and executes corresponding methods and/or instructions. For example, the electronic processor 110 is configured to receive a scroll command. In the illustrated embodiment, when the computing device 100 includes a touchscreen, the scroll command includes a swiping motion (typically a vertical swiping motion) from a user. In response, the electronic processor 110 scrolls through the various elements in a list shown on the display 125 using a continuous scroll method. When executing the continuous scroll method, the electronic processor 110 displays each of the elements in the list an equal amount of time, and a scroll rate (i.e., how fast the elements are scrolled) depends on the speed of the detected swiping motion. The scroll command is also associated with a direction. Typically, the direction is either up or down, although in some embodiments, the direction associated with the scroll command can be either left or right. The direction of the scroll command indicates to the electronic processor 110 a direction in which to scroll the elements on the list. For example, if the direction of the scroll command is up, the elements on the list are moved up to display elements that are lower in the list. On the other hand, if the direction of the scroll command is down, the elements on the list are moved down to display elements that are higher in the list.

Sometimes, however, it is inefficient to scroll continuously through all of the elements in a large list to find a particular element or an element of a particular type. To further facilitate navigation of the lists generated by the public safety application 130, or the electronic mail application 135, the electronic processor 110 also implements a method of discrete scrolling through the list. The discrete scrolling method, in contrast to the continuous scrolling method described above, jumps from a first element of a first type to the next element of the same type, thereby skipping any elements between the first element and the second element that are not of the same type as the first element and the second element. Using the discrete scrolling method, the computing device 100 facilitates efficient location of a particular element of interest or of an element of a particular type.

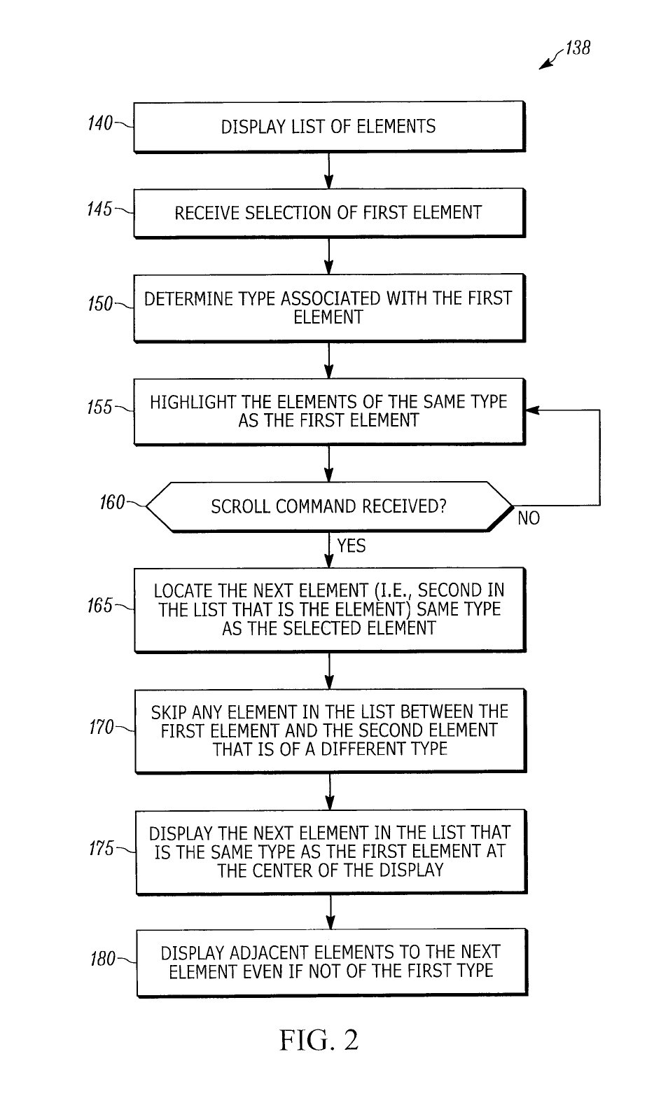

FIG. 2 illustrates a method 138 of discrete scrolling implemented by the electronic processor 110. In the example provided, the electronic processor 110 first displays a list of elements (block 140). The list of elements is generated by one of the applications (for example, the public safety application 130 or electronic mail application 135) stored in the memory 115. At block 145, the electronic processor 110 then receives a selection of a first element through, for example, the input controls 120 or the display 125 (e.g., when the display 125 is a touchscreen). The electronic processor 110 may receive the selection, for example, by detecting a particular gesture on the touchscreen. In the illustrated embodiment, the electronic processor 110 detects a slight left swiping motion at the location of the first element. In response to receiving the selection of the first element, the electronic processor 110 determines a type associated with the first element (block 150). The type of the first element varies based on the application used to generate the list, the elements in a particular list, and the overall nature and/or purpose of the list. For example, the list generated by the electronic mail application 135 may include elements having a type associated with, for example, a sender, a recipient, a date, a subject line, and the like. However, a list generated by a music application may include elements having a type associated with, for example, an artist, genre, date, album, and the like.

After the electronic processor 110 identifies the type associated with the first element, the electronic processor 110 then proceeds to highlight the elements in the list that are of the same type as the first element (block 155). In other words, the electronic processor 110 highlights a subset of elements of the list of elements, where the subset of elements are of the same type. If the list is relatively small (i.e., few number of elements in the list), highlighting the elements of the same type as the first element (e.g., the selected element) may provide sufficient emphasis for a user to efficiently locate an element of interest. If the list is large (i.e., several elements in the list), however, not all of the elements in the list may be displayed on the display 125 at once. In such situations, an element of interest may not be readily located, even if highlighted by the electronic processor 110. As shown in FIG. 2, the electronic processor 110 determines whether a scroll command is received (block 160). While the electronic processor 110 does not receive a scroll command, the electronic processor 110 continues to highlight the elements of the same type until a scroll command is received, the window and/or application is closed. When the electronic processor 110 receives the scroll command, the electronic processor 110 accesses and displays elements on the list not originally shown on the display 125.

As discussed above, the scroll command may include a swiping motion in a vertical, horizontal, diagonal or any pre-defined direction or shape. In other embodiments, the scroll command may include an activation of a scroll bar, or similar graphical user interface element (e.g., a virtual or “soft” arrow). In response to receiving the scroll command, the electronic processor 110 locates the next element (i.e., a second element) in the list that is of the same type as the first element (block 165). When the electronic processor 110 locates the next element in the list, the electronic processor 110 locates the next element in the direction of the scroll command such that, for example, if the scroll command has an associated upward direction, the next element lower on the list is located, and if the scroll command has an associated downward direction, the next element higher on the list is located by the electronic processor 110. The electronic processor 110 also skips any elements between the first element and the second element that are not of the first type (block 170). In other words, the electronic processor 110 skips any elements that are of a different type than the first element and the second element. By skipping the elements that are associated with a different type than the selected first element, the discrete scrolling method provides a faster navigation through a list of elements because not all of the elements are displayed as in the continuous scrolling method. Notably, if the next element in the list is adjacent the first element (i.e., the selected element), the electronic processor 110 bypasses block 170 since there are no elements between the first element and the second element.

Finally, the electronic processor 110 displays the second element (i.e., the next element) at the center of the display 125 (block 175). In other embodiments, the electronic processor 110 may display the second element at a different location of the display 125 such as, for example, the top of the display 125 or the bottom of the display 125. By displaying the second element at a predetermined location of the display 125, the electronic processor 110 provides an indication that the discrete scrolling method has advanced to the next element and readily displays the second element at an expected location. Consequently, a user can identify that the discrete scrolling method has advanced to the next element and provide another scroll command to the computing device 100.

Optionally, the electronic processor 110 displays elements that are adjacent to the second element even if the adjacent elements are not of the first type (block 180). In other words, the electronic processor 110 jumps to the second element, which is the next element of the same type as the first element, displays the second element at a predetermined location of the display 125, while also displaying elements of different types that are adjacent to the second element. By displaying the adjacent elements to the first and second elements of the first type, the discrete scrolling method maintains and displays certain context for the first and second elements. In other words, the adjacent elements, even though they are associated with a different type, may still provide some context for the elements of the first type. Accordingly, by displaying the adjacent elements, the discrete scrolling method maintains the context associated with the elements of the first type.

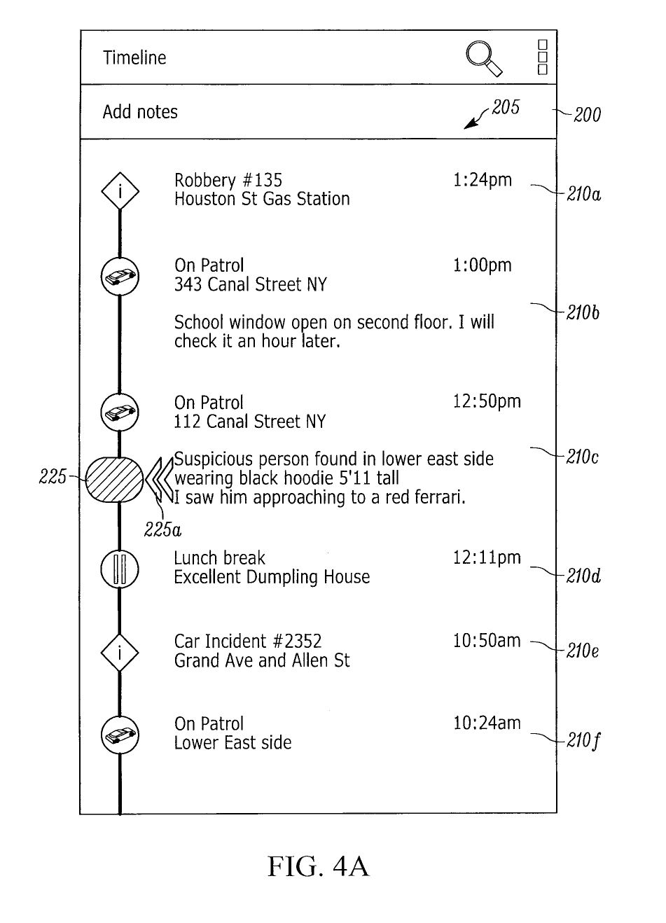

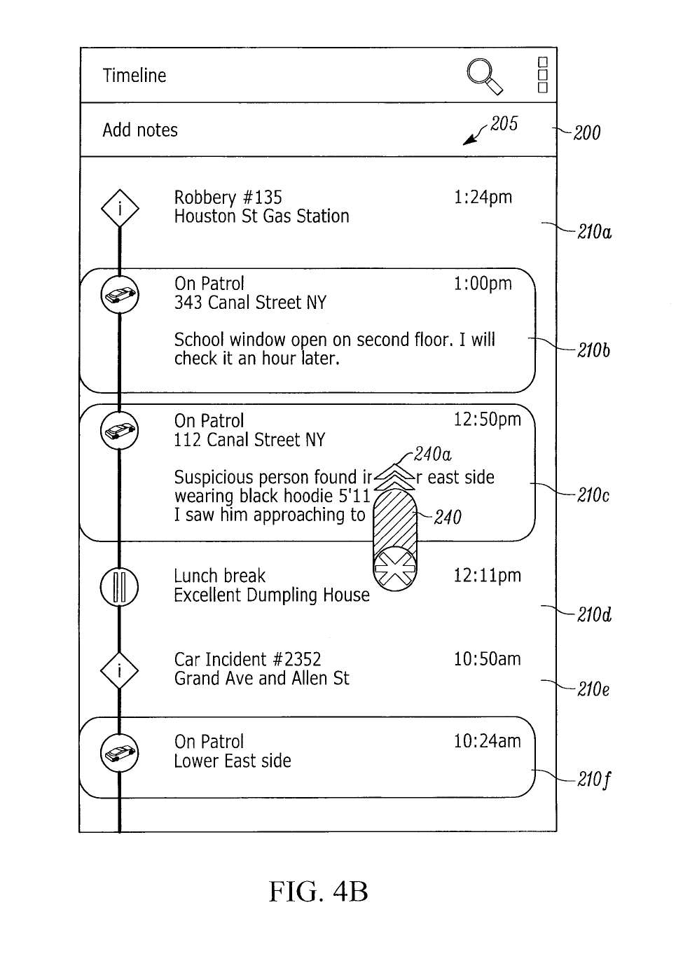

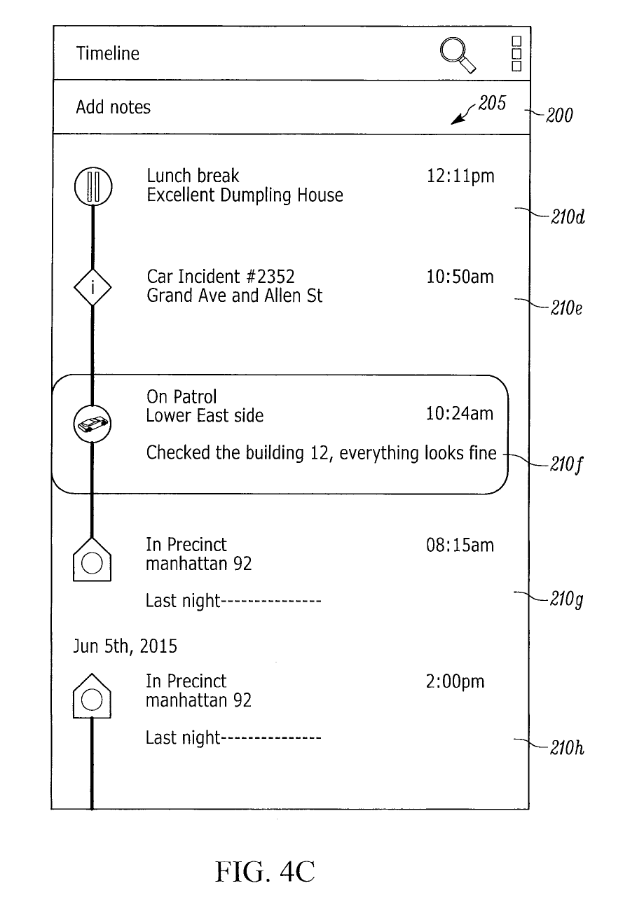

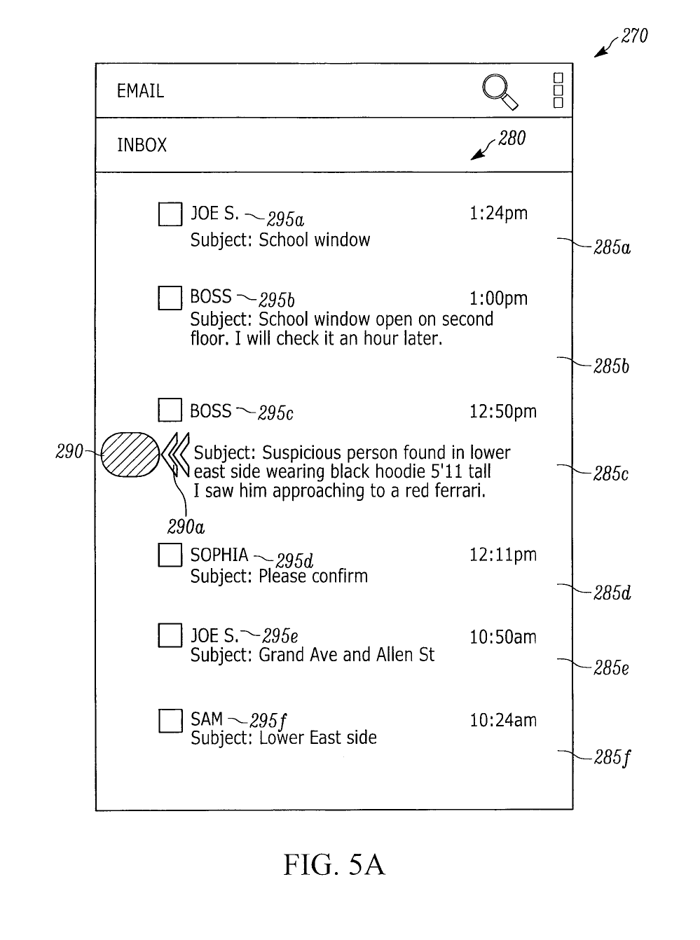

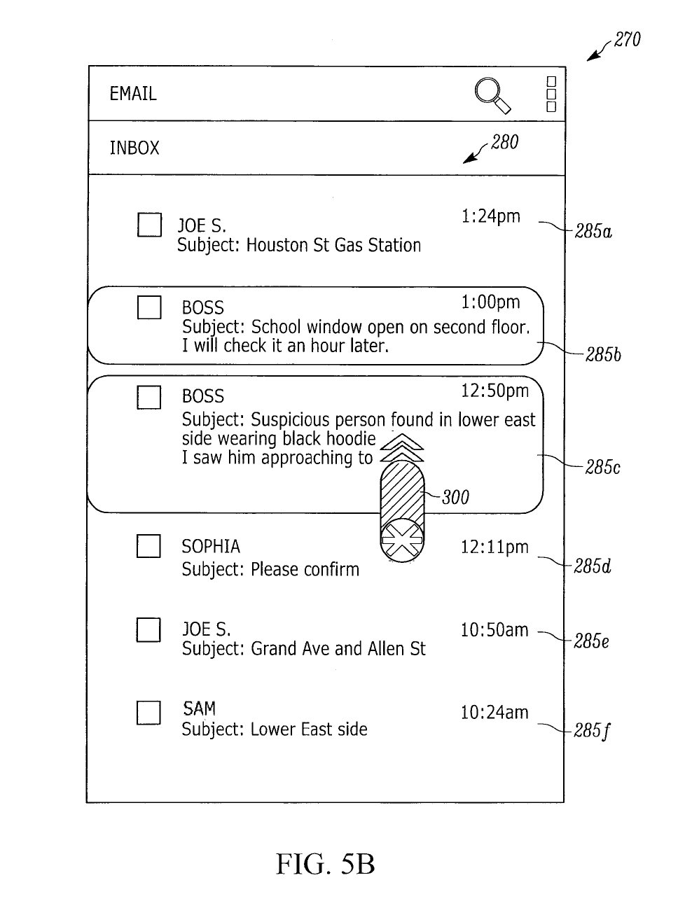

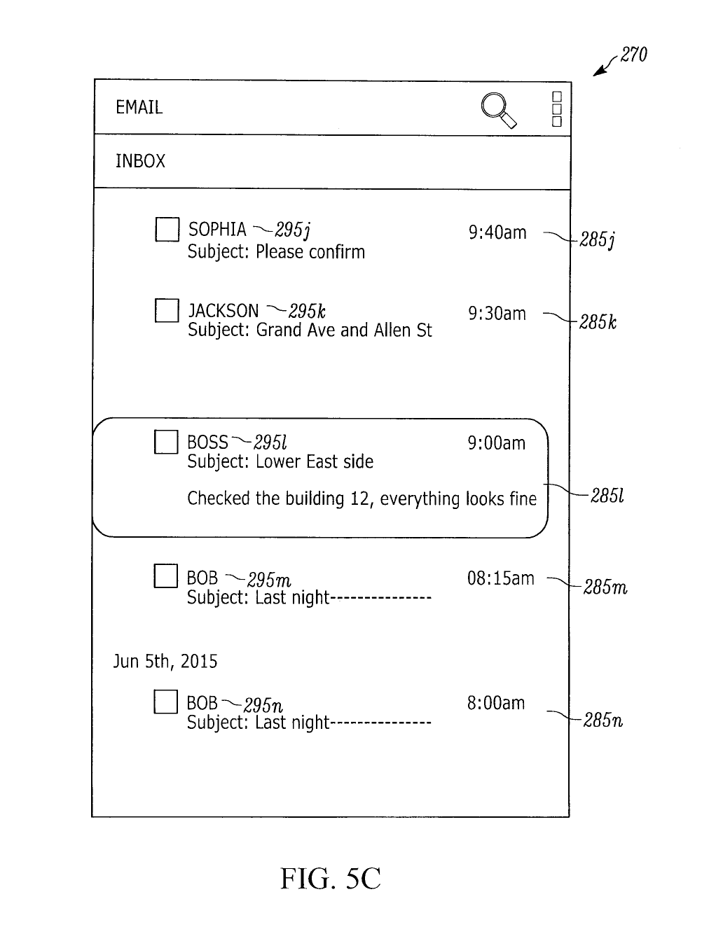

As shown by FIGS. 4A through 5C, the discrete scrolling method 138 is implemented by the electronic processor 110 to navigate through the lists generated by the public safety application 130 and the electronic mail application 135, as well as other applications that may be stored in the memory 115. The public safety application 130, for example, may be configured to track public safety events associated with a particular responder and/or agency. The public safety events may be automatically determined based on, for example, responder activity through the computing device 100 (e.g., calling information to a central agency, calling another public safety agency for help, obtaining travel directions to or from an emergency location), or the public safety events may be manually entered on the computing device 100 through the input controls 120. In other embodiments, such as the illustrated embodiment, the public safety application 130 automatically determines some public safety events and is also configured to receive manually entered public safety events. The public safety application 130 may additionally receive confirmation from a user regarding the public safety events that are automatically determined, and during confirmation may receive additional information regarding the event such as, for example, a summary of the incident, participants in the activity, duration of the activity, and the like. In the illustrated embodiment, the public safety application 130 also associates a location with each public safety event.

In some embodiments, each public safety event is classified into one type or category. Each type may differ, for example, by public safety agency and services provided by the public safety agency. In the illustrated embodiment, the type associated with each public safety event is based on an activity characterizing the event. In the illustrated embodiment, the public safety events can be associated with one of the following types: a robbery type, a gun pull type, an on patrol type, a car incident type, an accident type, a fire type, and a medical emergency type. Therefore, in the illustrated embodiment, the electronic processor 110 determines a type of a selected event by determining an activity associated with the event.

FIGS. 4A through 4C illustrate a graphical user interface (GUI) 200 generated by the public safety application 130. As shown in FIGS. 4A-4C, the graphical user interface 200 includes a timeline 205 listing a plurality of public safety events 210a through 210h. The public safety application 130 sorts the public safety events 210a through 210h by date and time of occurrence, such that the public safety events 210a through 210h are arranged in chronological order. Having the public safety events 210a through 210h arranged in chronological order provides context information for each of the public safety events 210a through 210h. For example, a responder can analyze the location of, for example, a robbery event 210a and determine the distance between the robbery event 210a and the following on patrol event 210b, an amount of time that the responder spent attending to the robbery event 210a, and what the responder observes during the following on patrol event 210b. This type of context may be useful when coordinating efforts from different public safety agencies, or when reporting particular public safety events.

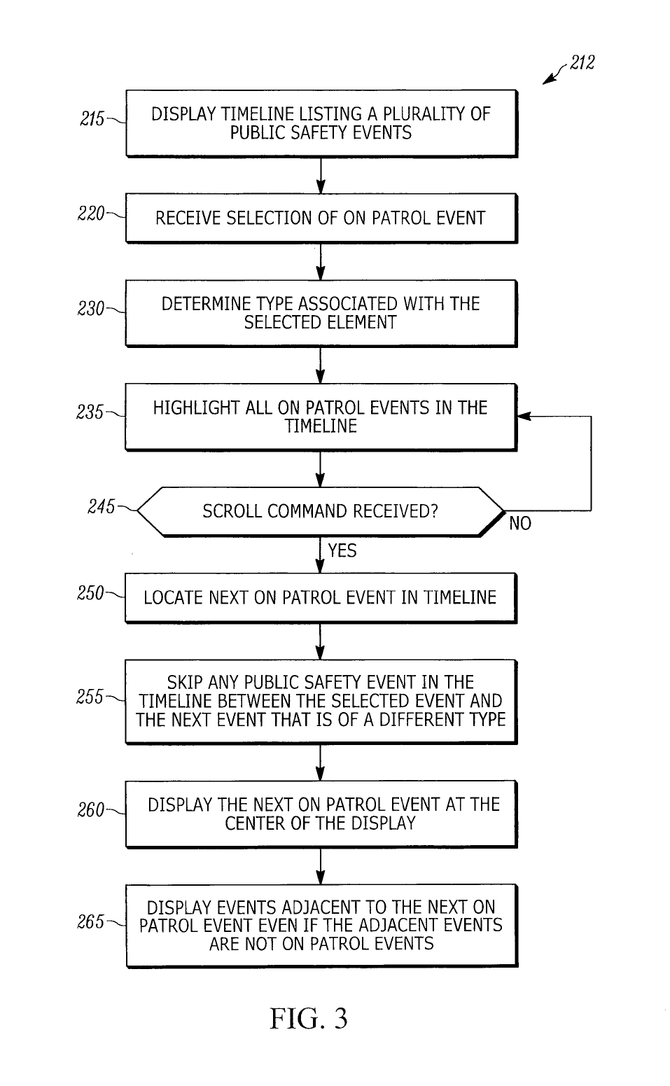

FIG. 3 illustrates an exemplary implementation of a discrete scroll method 212 executed by the electronic processor 110. FIGS. 4A through 4C illustrate changes in the graphical user interface 200 that occur as the electronic processor 110 implements the discrete scroll method 212. As shown in FIG. 3, the electronic processor 110 first displays the timeline 205 listing a plurality of public safety events 210a through 210h (block 215). The electronic processor 110 then receives a selection of an “On Patrol” event 210c (block 220). In the illustrated embodiment, the electronic processor 110 receives the selection of the “On Patrol” event 210c by detecting a left swipe at the location of on the “On Patrol” event 210c. FIG. 4A illustrates the selection with a first representative gesture marker 225 positioned over the “On Patrol” event 210c. The arrows 225a indicate the left motion of the gesture. In other embodiments, the selection of a particular event may include different motions and/or gestures directed to the selected event.

The electronic processor 110, in response to receiving the selection of the “On Patrol” event 210c, determines a type associated with the selected event 210c (block 230). In the illustrated embodiment, the electronic processor 110 recognizes that the timeline 205 is generated by the public safety application 130 and accesses information regarding the public safety application 130 to identify that the selected event 210c is associated an “On Patrol” type. Once the electronic processor 110 determines that the selected event (i.e., the selected “On Patrol” event 210c) is associated with an “On Patrol” type, the electronic processor 110 highlights all the events on the timeline 205 that are also “On Patrol” events 210b, 210c, and 210f (i.e., events of the same type) at block 235. FIG. 4B illustrates the graphical user interface 200 including the highlighted “On Patrol” events 210b, 210c, and 210f. The electronic processor 110 then determines whether a scroll command has been received by the electronic processor 110 (block 245). While the electronic processor 110 does not receive a scroll command, the electronic processor 110 continues to highlight the “On Patrol” events 210b, 210c, and 210f until a scroll command is received, or the window and/or application is closed. When the electronic processor 110 receives the scroll command, the electronic processor 110, in response to receiving the scroll command, locates and jumps to the next “On Patrol” event 210f on the timeline 205 (block 250). FIG. 4B also illustrates the scroll command with a second representative gesture marker 240. The arrows 240a on the second gesture marker 240 indicate the upward motion of the scroll command gesture. As discussed above, the scroll command gesture may be alternatively associated with a different direction. The electronic processor 110 locates the next “On Patrol” event 210f according to the direction of the scroll command (i.e., the closest or nearest “On Patrol” event according to the direction of the scroll command).

As shown in FIGS. 4A and 4B, the next “On Patrol” event (i.e., the second “On Patrol” event) is toward the bottom of the display 125 when the original “On Patrol” event 210c is selected on block 220. The electronic processor 110 proceeds to skip the public safety events 210d, 210e between the selected “On Patrol” event 210c and the second “On Patrol” event 210f and that are not “On Patrol” events (i.e., that are of a different type than the selected event) at block 255. The electronic processor 110 displays the next “On Patrol” event 210f at the center of the display 125 (block 260), as shown in FIG. 4C. As discussed above, in situations in which the next “On Patrol” event 210f is immediately adjacent the selected “On Patrol” event 210c, the electronic processor 110 does not skip any elements as defined in block 255 since there are no elements between the selected “On Patrol” event 210c and the next “On Patrol” event 210f. Even though the discrete scrolling method scrolls only through the elements that are of the same type, the electronic processor 110 continues to display the elements that are not of the same type as the selected event, but that are adjacent to the elements of the selected type (block 265). FIG. 4C illustrates the timeline 205 having the next “On Patrol” event 210f (i.e., the second “On Patrol” event) at the center of the display 125 and displaying several adjacent events that are not “On Patrol” events. In other words, even though implementing the discrete scrolling method scrolls only through the events of an “On Patrol” type (e.g., jumps from a selected event of a first type to the next event of the same type), the electronic processor 110 continues to display events of different types, as shown in FIGS. 4A through 4C.

FIGS. 5A through 5C illustrate changes in a graphical user interface 270, generated by the electronic mail application 135, when the electronic processor 110 implements the discrete scrolling method on a list of electronic mails generated by the electronic mail application 135. When electronic processor 110 implements the discrete scrolling method on the list of electronic mails generated by the electronic mail application 135, the discrete scrolling method follows processes that are generally similar to the processes shown in FIGS. 2 and 3. Accordingly, an additional flowchart specifically for an implementation with the electronic mail application 135 is not provided. As shown in FIGS. 5A through 5C, the graphical user interface 270 generated by the electronic mail application 135 includes an inbox 280 listing a plurality of electronic mails 285a through 285n. Typically, electronic mail applications such as the electronic mail application 135, receive a selection of a characteristic of the electronic mails 285a through 285n by which to sort the electronic mails 285a through 285n. In the illustrated embodiment, the electronic mails 285a through 285n are sorted by date received such that newest electronic mails are displayed at the top of the display 125 and older electronic mails are displayed toward the bottom of the display 125. In other embodiments, the electronic mails 285a through 285n may be sorted by, for example, a sender, a recipient, a subject line, an urgency indication, and the like. The flexibility to sort by different characteristics allows users to quickly and adaptably view and select electronic mails 285a through 285n from a particular inbox 280. However, each time the sorting characteristic is changed, the context for any given electronic mail 285a through 285n is also changed. For example, if the electronic mails 285a through 285n are first sorted by date received, electronic mails 285a through 285n that are received in close time proximity to each other are displayed adjacent in the inbox 280 (i.e., the context for each electronic mail 285a through 285n is time based). If the electronic mails 285a through 285n are then changed to be sorted by, for example, a sender of the electronic mails 285a through 285n, then emails 285a through 285n that are sent by the same person, or people with alphabetically similar names or usernames are displayed adjacent in the inbox 280 (i.e., the context for each electronic mail 285a through 285n is then alphabet based), and information regarding which electronic mails 285a through 285n are sent in close time proximity to one another is no longer provided and/or readily available.

Therefore, to maintain the time-based context for the electronic mails 285a through 285n and provide a faster and better way of navigating the inbox 280, the electronic processor 110 implements a discrete scrolling method. The electronic processor 110 first receives a selection of a particular electronic mail 285c, as shown by a third gesture marker 290 on FIG. 5A. As discussed above with respect to FIG. 4A, the arrows 290a on the third gesture marker 290 indicate a direction of motion of the third gesture marker 290. In the illustrated embodiment, the third gesture marker 290 indicates that the selection of the electronic mail 285c includes a swiping motion to the left. In response to the selection of the selected electronic mail 285c, the electronic processor 110 determines a type of the electronic mail 285c. The electronic processor 110 may access information regarding the electronic mail application 135 stored in the memory 115 to determine the type of the selected electronic mail 285c. Analogously to how the characteristic by which the electronic mails 285a through 285n are sorted in the inbox 280, the electronic processor 110 may also receive a selection of a characteristic that determines the type of a particular electronic mail 285a through 285n. In the illustrated embodiment, the type of each of the electronic mails 285a through 285n is determined by a sender 295 associated with each electronic mail 285a through 285n.

Once the electronic processor 110 determines the type (e.g., “Boss as sender” of the electronic mail) of the selected electronic mail 285c, the electronic processor 110 proceeds to highlight all the electronic mails that match the type of the selected electronic mail 285c. In the present example, the type is “Boss as sender”, therefore all the electronic mails for which Boss is the sender are highlighted by the electronic processor 110, as shown in FIG. 5B. If a particular electronic mail 285a through 285n of interest (i.e., matching a type of the selected electronic mail 285c) is not displayed on the display 125 (e.g., because the electronic mail of interest is further down in the list of electronic mails), the electronic processor 110 receives a scroll command as shown by the fourth gesture marker 300 shown in FIG. 5B. In the illustrated embodiment, the gesture marker 300 indicates an upward motion. Since the gesture marker 300 indicates an upward motion, the electronic processor 110 locates the next electronic mail 285l with Boss as a sender according to the direction of the scroll command. The electronic processor 110 then skips any electronic mails that do not have Boss as a sender, and instead displays the next electronic mail 285l that includes Boss as a sender at the center of the display 125. As shown by comparing FIGS. 5B and 5C, electronic mails 285g-i (not shown) between the selected electronic mail 285c and the next electronic mail with Boss as the sender 285l that do not include Boss as the sender, are skipped and not shown on the display 125. Instead, the next electronic mail having Boss as a sender 285l is automatically shown on the center of the display 125 along with any adjacent electronic mails 285j-k and 285m-n, even if the adjacent electronic mails are associated with different senders (i.e., not “Boss as sender”). Therefore, the discrete scrolling method provides an efficient method for navigating through a large list of elements by selectively scrolling only through elements of a same type, while, at the same time, continuing to display the adjacent elements even if the adjacent elements are associated with a different type.

Accordingly, the discrete scrolling method provides several advantages to other features offered to navigate through lists of elements. For example, in contrast to a sorting feature, the discrete scrolling method maintains an original context for the elements in the list while also allowing a fast scroll only through those elements having the same type as a selected element. Additionally, with respect to a search feature and/or a filter feature, the discrete scrolling method does not require an additional user interface element to indicate a particular filter characteristic or a search parameter, respectively. Rather, based on a selection of an element within the list, the electronic processor 110 is configured to automatically (e.g., without user input) detect the type of the selected element. Furthermore, while the search feature and the filter feature display only those elements in the list that match the filter characteristic or search parameter, respectively, the discrete scrolling method displays both the elements matching the type of the selected element and the elements that do not match the type of the selected element, thereby providing a wider context for the elements matching the type of the selected element.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein.

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of discrete scrolling between elements in a list of elements, the method comprising:
displaying, on a screen of a computing device, a list of elements;
receiving, via an input interface, a selection of a first element of the list of elements;
determining, with an electronic processor of the computing device, a type of the first element in response to receiving the selection of the first element;
determining a second element of the list of elements having a type that is the same as the type of the first element and being a closest element in the list of elements of the same type as the type of the first element;
receiving, at the electronic processor of the computing device, a scroll command; and
in response to receiving the scroll command, displaying the second element at a predetermined location on the screen of the computing device.

2. The method of claim 1, further comprising highlighting a subset of elements of the list of elements, wherein each of the elements in the subset of elements is associated with the same type as the type of the first element.

3. The method of claim 1, wherein displaying the second element at the predetermined location of the screen includes displaying the second element at a center of the screen of the computing device.

4. The method of claim 1, wherein displaying the second element at the predetermined location of the screen includes displaying the second element at the top of the screen of the computing device.

5. The method of claim 1, wherein displaying the list of elements includes displaying a list of events arranged in a chronological order.

6. The method of claim 5, wherein determining the type of the first element includes determining a type of activity associated with each event of the list of events.

7. The method of claim 6, wherein displaying the list of events includes displaying a list of public safety events, and wherein determining the type of activity associated with each event of the list of events includes determining whether the type of activity is one selected from a group consisting of a gun pull event, a robbery event, an on patrol event, a car incident event, an accident event, a fire event, and a medical emergency event.

8. The method of claim 1, further comprising displaying elements of the list of elements that are adjacent to the second element while the second element is displayed at the predetermined location of the screen of the computing device, the elements that are adjacent to the second element being associated with at least one type different than the type associated with the first element and the second element.

9. The method of claim 1, wherein displaying the second element at the predetermined location of the screen of the computing device includes skipping at least one element of the list of elements, between the first element and the second element, that is associated with a different type than the first type associated with the first element and the second element.

10. The method of claim 1, wherein receiving, via an input interface, the selection of the first element includes receiving an input via a touchscreen, and wherein receiving the scroll command includes receiving the scroll command via the touch screen.

11. A computing device comprising:
a screen;
an input interface; and
an electronic processor coupled to the screen and the input interface, the electronic processor configured to
display on the screen a list of elements,
receive a selection, via the input interface, of a first element of the list of elements,
determine, in response to receiving the selection of the first element, a type of the first element,
receive, via the input interface, a scroll command, and
display, in response to receiving the scroll command, a second element of the list of elements at a predetermined location of the screen, the second element being associated with the same type as the first element, the second element being a closest element in the list of elements of the same type of the first element.

12. The computing device of claim 11, wherein the electronic processor is further configured to highlight a subset of elements of the list of elements, wherein each of the elements in the subset of elements is associated with the same type as the type of the first element.

13. The computing device of claim 11, wherein the predetermined location of the screen includes a center of the screen of the computing device.

14. The computing device of claim 11, wherein the predetermined location of the screen includes a top of the screen of the computing device.

15. The computing device of claim 11, wherein the list of elements includes a list of events arranged in a chronological order.

16. The computing device of claim 15, wherein the electronic processor is configured to determine the type of the first element by determining a type of activity associated with each event of the list of events.

17. The computing device of claim 16, wherein the list of events includes a list of public safety events, and wherein the electronic processor is configured to determine the type of activity associated with each event by determining whether the type of activity is one selected form a group consisting of a gun pull event, a robbery event, an on patrol event, a car incident event, an accident event, a fire event, and a medical emergency event.

18. The computing device of claim 11, wherein the electronic processor is further configured to display elements of the list of elements that are adjacent to the second element while the second element is displayed at the predetermined location of the screen, the elements that are adjacent to the second element being associated with at least one type that is different than the type associated with the first element and the second element.

19. The computing device of claim 11, wherein the electronic processor is further configured to skip at least one element of the list of elements, between the first element and the second element, that is associated with a different type than the type associated with the first element and the second element.

20. The computing device of claim 11, wherein the selection of the first element includes a first touch input via a touchscreen, and wherein the scroll command includes a second touch input via the touch screen.
